(19) United States
(12) Patent Application Publication
(10) Pub. No.: US 2008/0134982 A1
(43) Pub. Date: Jun. 12, 2008

(54) Animal shred

(76) Inventors: Gary E. Thormodsgaard, Huntington Beach, CA (US); Elayn D. Ward, Huntington Beach, CA (US)

Correspondence Address: Kit M. Stetina, Esq.;STETINA BRUNDA GARRED & BRUCKER, Suite 250, 75 Enterprise, Aliso Viejo, CA, 92656, US

(21) Appl. No.: 11/636,864

(22) Filed: Dec. 11, 2006

(51) Int. Cl. A01K 29/00

(52) U.S. Cl. 119/172

(57) ABSTRACT

An animal shred comprising an absorbent paper stock for use as a bedding material, wherein the paper stock is folded into signature, shredded, dusted and packaged in a vacuum sealed package. The paper stock may have a design printed thereon on one or both sides utilizing organic or soy-based ink. An animal shred manufacturing process comprising selecting a paper stock; folding the paper stock into signature; shredding the paper stock; dusting the shredded paper stock using a dust collection system and vacuum packaging the paper stock. A scent treatment, such an odorant or a flea deterrent, may be applied to the animal shred. The animal shred may be used as a filler for a cushion, which may be disposable, or the bedding material may be placed in an animal enclosure.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to an animal shred and its method of manufacture. More specifically, the present invention relates to an absorbent shredded paper stock that can be used as a bedding material for nesting and/or absorbing animal waste. The invention also relates to a method of manufacturing and packaging the absorbent shredded paper stock.

Animal enclosures are utilized to accommodate, confine and transport pets or other types of animals for many purposes. For example, veterinarians must board or otherwise confine animals during extended visits for treatment. Similarly, pet stores and breeders must maintain adoptable animals in some type of living quarters until they are adopted. The living quarters may also function as a display cage for the animal. Pet owners may also choose to contain an animal in an enclosure for behavioral reasons during the night or while the pet owner is not at home. Certain animals, such as guinea pigs or ferrets, spend a majority of their lives inside an enclosure. Depending on the circumstances, the animal generally must play, sleep, and if necessary, excrete waste while in the enclosure. Thus, the enclosure must be large enough to accommodate each of these needs simultaneously so that sanitary living conditions can be maintained without constant human supervision.

The most common type of enclosure is a free-standing cage constructed from a sturdy material, such as wire or plastic. Another type of enclosure used to confine an animal is a cage that is integral with a building structure. An absorbent material, such as a paper product or other similar material, can be used in connection with an enclosure to serve as a bedding material and/or absorb at least a portion of waste that may be excreted from the animal. The absorbent material may be placed inside the enclosure with the animal or in a portion of the enclosure adapted to separate any excreted waste product from the confined animal.

A wide variety of products can be used as a bedding material in connection with an animal enclosure, including but not limited to, pine shavings, corn cob products and printed newspaper. Disadvantages exist with respect to each of these bedding materials. For example, pine shavings have been found to be harmful to animals and humans under certain circumstances due to the aromatic oils that are released from the shavings. The oils are known to elevate the levels of some liver enzymes, which can also affect the metabolism of drugs and other compounds. The aromatic oils may further cause allergic reactions. Next, corn cob products tend to grow moldy fairly quickly causing the product to be full of bacteria. The corn cob product can be very unhealthy and dangerous to both the animal and the human caretaker due to the large amount of bacteria that may be present even after a short period of use. Moreover, an animal that is in a caged situation may be experiencing a tremendous amount of stress. The animal may eat the corn cob product as a way to relieve this stress. Most animals cannot digest corn cob products and may become very sick or die.

Recycled newspaper is likely the most common of the bedding material for use in connection with an animal enclosure because it is inexpensive and easy to obtain. Recycled newspaper can either be placed flat in an enclosure, or the newspaper can be shredded, by hand or mechanically, and placed inside the enclosure to be used as a bedding material for nesting, playing and/or absorbing excreted waste. Newsprint, which is the lightweight paper on which newspapers are printed, is made mainly from wood pulp. Newsprint is durable to withstand the repeated manipulation and handling to which a newspaper is subjected. However, the newsprint is generally thin and, thus, not very absorbent of liquid or odors normally associated with excreted waste. Extra steps must be taken when cleaning the enclosure and changing the bedding material because the excreted waste may not have been properly absorbed by the recycled newspaper.

Also, recycled newspaper contains ink which can be very dirty and perhaps toxic. When the human caretaker changes the bedding material, the ink is from the newspaper is inevitably transferred onto the portions of the caretaker's skin that are in contact with the newspaper during handling. Previously, the newspaper ink used by most printers contained toxic chemicals, including lead and cadmium. Many printers have phased out the use of these chemicals for newspaper printing. However, the glossy advertising inserts that typically accompany a newspaper may still contain these hazardous chemicals. Thus, the animal and the human may still be regularly exposed to these chemicals if the advertising inserts are used as a bedding material.

Newsprint is basically uncoated paper that has a fibrous surface. Depending on how the newsprint is manufactured, the newsprint may have a fiber content that ranges from seventy to ninety percent of each sheet. When recycled newspaper is used as a bedding material or liner for an enclosure, the newspaper is generally shredded and then immediately utilized. The combination of the ink, the lower paper weight and the fiber content of the newsprint may cause substantial dust when the paper is shredded. Handling the bedding material may be hazardous to both the human caretaker and the animal because handling can cause the release of dust into the surrounding atmosphere which may result in respiratory problems.

What is lacking in the art is a product that can be used as a bedding material and/or a liner for an animal enclosure. The bedding material should not only be absorbent and dust-free, but also inexpensive and easy to obtain. The material should also have a pleasant smell and be nontoxic to humans and animals.

### BRIEF SUMMARY

An animal shred comprising an absorbent paper stock for use as a bedding material wherein the printed paper stock is folded into signature, shredded, dusted and packaged in a vacuum sealed packaging. The animal shred may further comprise a design that is printed on one or both sides of the paper stock. The design may be printed on the paper stock using a web offset press. The design may be printed using an organic, or soy-based ink. The animal shred may be custom printed so that a pet owner may have bedding material manufactured having a pet's name or likeness printed thereon. The animal shred may be used as a filler for a cushion, which may further be disposable, or the shred may be placed in an animal enclosure.

The animal shred may be nontoxic and contain less dust than conventional animal bedding material manufactured from recycled newspaper. The animal shred may be printed using an organic or soy-based ink. The paper stock used to manufacture the animal shred should be at least a forty-pound paper stock. Paper stock having a higher paper weight is generally more absorbent and creates less dust when shred.

The animal shred may be treated with a scent material to eliminate the smell normally associated with other bedding materials. A scent treatment, such as a cosmetic grade cedar odorant, may be applied to the paper stock at any time during the manufacturing process of the bedding material. Other scent treatments, such as a flea deterrent, may also be applied to the paper stock. The scent treatment may be mixed with a solvent, such as dipropylene glycol, prior to application to the paper stock.

A process of manufacturing an animal shred comprising the steps of: selecting a paper stock; folding the paper stock into signature; shredding the paper stock; dusting the shredded paper stock using a dust collection system and vacuum packaging the paper stock. The process of manufacturing the animal shred may further comprise the step of creating a print design. The print design may be transferred to the paper stock using a web-offset press. An organic, or soy-based ink, may be used to print the design on the paper stock.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of an enclosure with an animal shred inserted therein according to an aspect of the invention.

FIG. 2 is a perspective view of a cushion which utilizes the animal shred as a filler according to an aspect of the invention.

FIG. 3 represents the animal shred.

FIG. 4 is a pictorial diagram of a manufacturing process for producing the animal shred according to an aspect of the present invention.

### DETAILED DESCRIPTION

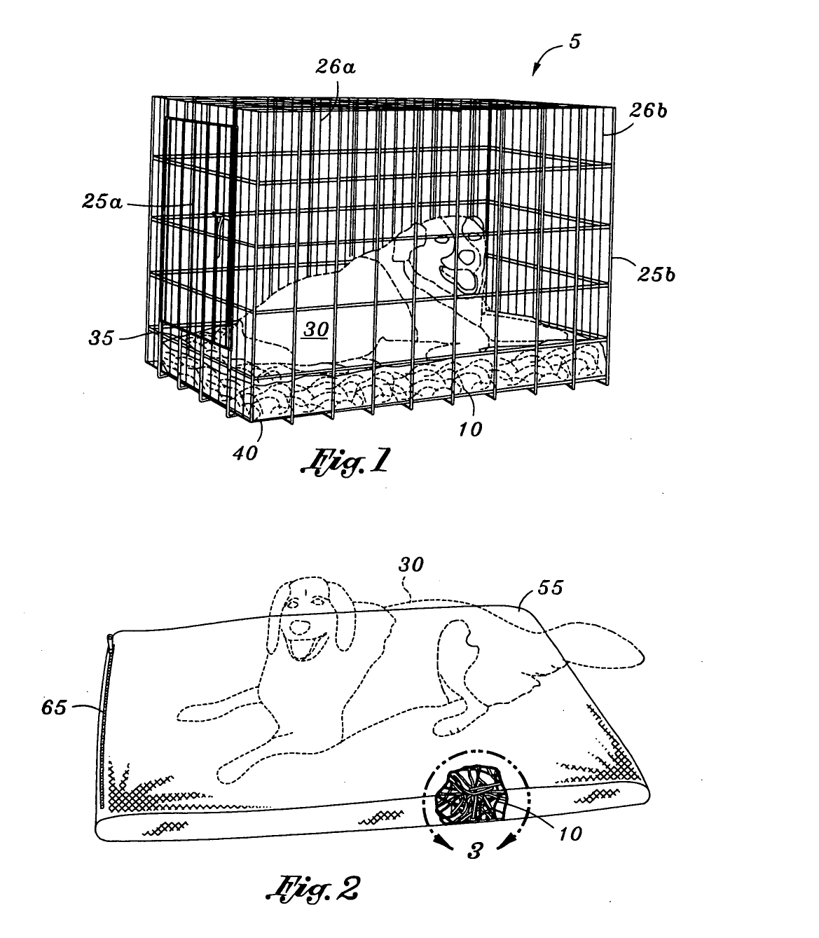

FIG. 1 represents a perspective view of an enclosure 5, containing a shred 10, as further described herein, and further containing a confined animal 30. Although the enclosure 5 shown in FIG. 1 is a portable enclosure, it can be appreciated by one skilled in the art that the shred 10 may be utilized in association with any type of enclosure 5, such as an enclosure 5 that is integral with a wall or other part of a building structure. The enclosure 5 shown in FIG. 1 has a welded wire construction, but the enclosure 5 may be constructed of any material that is sufficiently sturdy to restrain an animal 30, including but not limited to plastic or steel. The enclosure 5 shown in FIG. 1 is a cage having a top panel 20, two pairs of opposing side walls 25a, 25b and 26a and 26b, and a floor 35 that is elevated above a bottom panel 40 of the enclosure. The top 20, the sides 25a, 25b, 26a and 26b and the floor 35 define an interior of the enclosure 5 in which an animal 30 may be restrained and confined. The sidewalls 25a, 25b, 26a and 26b extend from the top panel 20 to the bottom panel 40. The portion of the cage bounded by the floor 35, the bottom panel 40 and the side walls, 25a, 25b, 26a, and 26b comprise a separate area into which a pan or tray (not shown) may be inserted. The pan or tray (not shown) should be constructed from a leak-proof material that may be easily cleaned.

The animal 30 shown in FIG. 1 is a dog, but it should be appreciated that the animal 30 may be any animal that is normally restrained and confined within such an enclosure 5 including but not limited to, a dog, a cat, a guinea pig, a bird, a rabbit or a reptile. The enclosure 5 may be located in any environment, including but not limited to, a veterinarian's office, a breeder site, a kennel, a groomer's place of business, a pet store or the pet owner's home.

As shown in FIG. 1, an appropriate amount of shred 10 is inserted into the portion of the enclosure 5 defined by the floor 35, the sides 25a, 25b, 26a and 26b and the bottom panel 40 of the enclosure 5. The animal 30 is contained within the enclosure 5 and may excrete waste as necessary through the floor 35 which may then be absorbed by the shred 10. The floor 35 separates the animal 30 from the waste-containing shred 10. If the enclosure 5 is provided with the pan or tray (not shown), as described above, the same may be used to contain the shred 10. The pan (not shown) may be removed from the enclosure 5, as necessary, to change the shred 10. Fresh shred 10 may be placed into the pan (not shown) which is reinserted into the enclosure 5. Alternatively, the shred 10 may be placed in the area of the enclosure 5 in which the animal 30 is contained. The shred 1O may be used for nesting, playing or absorbing excreted waste.

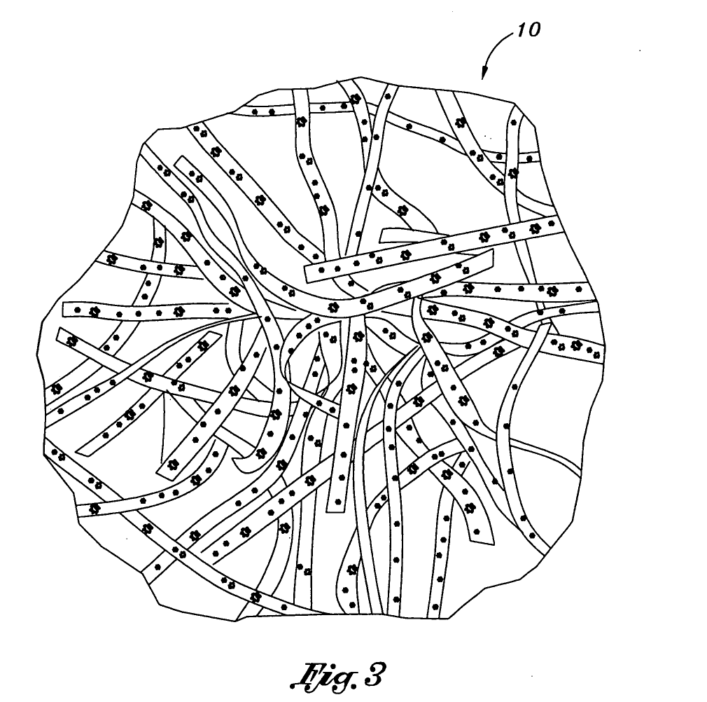

FIG. 2 is a perspective view of a cushion into which an appropriate amount of shred 10 is inserted and utilized as a filling or bedding material. The cushion shown in FIG. 2 is substantially in rectangular shape, but it can be appreciated by one skilled in the art that the cushion can be formed into any shape that can be adapted for the insertion of shred 10 therein. The cushion comprises a casing 55 that is preferably constructed from any flexible, durable material that may be suitable for use as an animal bed, including but not limited to plastic, leather, vinyl, denim, cotton, polyester and nylon. The casing 55 may be constructed from a soil resistant material so that the material repels dirt. The casing 55 may also be constructed from a waterproof material so that liquids, including animal excretions, are not absorbed by the material. The casing 55 may also be treated with a protective coating capable of providing either or both properties of water and soil resistance.

The cushion of FIG. 2 has an opening along its perimeter to facilitate the insertion of an appropriate amount of shred 10 into the casing 55. The cushion further comprises a closure device 65 to seal the opening of the casing 55. The closure device 65 may be any device, such as a zipper, that is used to close the opening of the casing 55 and maintain the shred 10 inside the cushion. In FIG. 2, an animal 30 is shown resting comfortably on the cushion. If the animal 30 accidentally excretes any waste onto the cushion, the shred 1O contained within the casing 55 may absorb at least some of the excreted waste. Any portion of the shred 10 may be removed from the casing 55 at any time to insert fresh shred into the casing 55 or to wash the casing 55. Alternatively, the casing 55 may be constructed from a disposable material such that the entire cushion may be discarded if it becomes soiled.

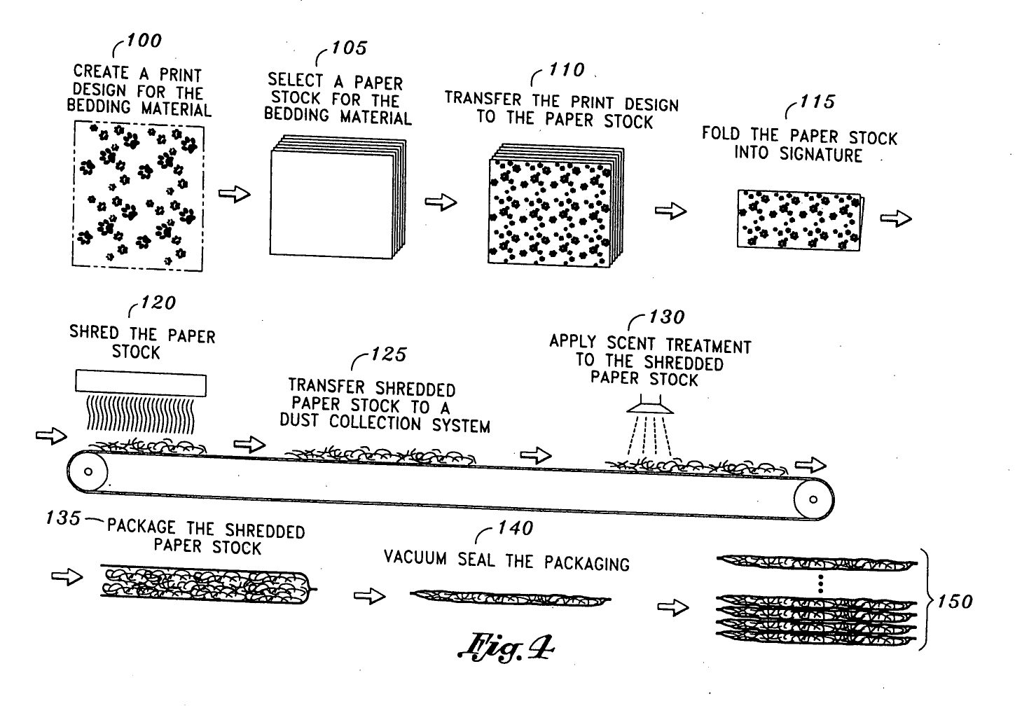

FIG. 4 is a pictorial flow chart that represents the process by which the shred 10 illustrated in FIG. 3 is manufactured and packaged. At 100, a print design may be created for the shred, if desired. The concept and appearance of the print design can be selected from an almost unlimited number of designs. Almost all limitations on the print design are based on the preference of the manufacturer or the end-user. For example, a print design may be selected that is generally related to animals, or the print design may be relevant to a type of animal that may utilize the shred. The print design may include a paw print or the design may comprise a repeated word or sequence of words that may generally refer to animals. The print design may also include a depiction of a cat, dog or other similar animal that may utilize the bedding. If the animal shred is to be utilized in a retail setting, such as a pet store, the print design may comprise the store name, logo or any other mark that is generally associated with the store. Similarly, if the animal shred is used in a veterinarian's office, the print design may be the appropriate name of the doctor or the veterinarian practice. The manufacturing process, as further described herein, may be adapted such that it can be used to produce smaller quantities of animal shred for custom printing orders. For example, a pet owner may wish to order animal shred that has the name or likeness of the owner's pet printed thereon.

Once the print design is conceptualized and developed, an original artwork template of the print design may be generated. The original artwork template may be comprised of photographs, illustrations and text. Each element of the original artwork template is combined into a single document that is in the form of a digital image or file using a page make-up software. Printing plates are required to transfer the artwork design to the paper stock, as further described herein. A direct-to-plate process is utilized to create the printing plates. Specifically, the digital file of the artwork is ripped and electronically imaged using a plate image setter. Lasers are utilized to etch the print design onto the printing plate, which is then washed with a water and mild chemical mixture. Alternatively, a conventional photochemical process may be used to make the printing plates.

A paper stock having an appropriate weight is selected for the animal shred at 105. It is well known in the art that the weight of paper stock is determined by calculating the weight of a ream of paper that corresponds to the size of the paper for which the weight is being determined. Paper stock having a higher weight is generally more absorbent. The paper stock that is used as newsprint is generally around twenty-four pound paper stock. As previously described, newsprint is typically not very absorbent despite its frequent use as a bedding material and/or a cage liner. An absorbent paper stock is desired for use as a bedding material, and preferably, the paper stock selected for the shred is at least forty pound clay-coated paper stock. The clay-coating on the paper stock reduces the dust that is generated during the shredding process and holds any scent treatment that may be applied to the paper stock, as further described herein.

The artwork design may be printed onto the paper stock at 110 using a printing press, which is preferably a web offset press. A web offset press is one type of printing press that processes rolls of paper stock as compared to single sheets. A suitable example of a web offset press is the Solna D300 which is sold by Solna Americas, Inc. in Lenexa, Kans. One skilled in the art should appreciate that the manufacturing process may be adapted such that any type of printing press may be used in accordance with the features of the invention. During each cycle of the press, the print design is imaged onto a blanket cylinder which then transfers the image onto the paper stock. The print design may be transferred to both sides of the paper stock or the print design may only be printed on one side of the paper stock. The ink used to transfer the design to the paper stock is preferably an organic ink, such as a soy-based ink, which contains non-toxic soybean oil and can create a vivid color design. Other types of ink may also be used in the transfer of the design to the paper stock including solvent-based, water-soluble or other organic inks.

At 115, the printed paper stock is folded into signature to facilitate and expedite the shredding process. Signature refers to the configuration of two or more sheets of paper that are stacked and folded as a group a certain number of times to make a folded section. The signature into which the paper stock is folded depends on the type of shredding device that is used to shred the printed paper stock. For example, certain shredders may only be able to handle a certain thickness of paper in connection with the shredding process. If the signature of the paper stock is too thick, the shredder may become jammed with the paper stock. The printing press used to transfer the print design onto the paper stock may include a folding mechanism for folding the paper stock into signature. Alternatively, a folding device may be a piece of equipment that is separate from the printing press and folds the paper stock into signature subsequent to the transfer of the print design onto the paper stock.

At 120, the paper stock is shred by feeding one or more signature sections into a shredding device. One suitable shredding device is the IPD16RC sold by Industrial Paper Shredders, Inc. of Ohio. It can be appreciated that other brands or types of shredding or cutting devices may be used to shred the paper stock into strips. The size of the shredded paper strips depends on the shredding device used to shred the paper stock and how the paper stock is inserted into the shredding device.

After the paper stock is shredded, the pieces of shredded paper stock exit, or are otherwise removed from, the shredding device. The pieces of shredded paper stock are transferred to a dust collection system at 125. The dust collection system is provided to remove and collect any paper fiber dust particles of the shredded paper stock that may be created as a result of the shredding process. The dust collection system may be further adapted to remove dust particles from the environment in the location of the shredding device so that the shredding device may be operated in almost any location. Many shredding devices have a dust collection system that is integral to the shredding device. However, if the shredding device does not include a dust collection system, the shredded paper stock may be transferred to a separate dust collection system subsequent to the shredding process. The dust collection system may be a shaker or a vacuum removal system.

At 130, a scent treatment may be applied to the shredded paper stock, if desired. The scent treatment may include a liquid scent such as a cosmetic grade cedar odorant of the type used to repel insects. Other types of scent treatments may also be applied to the shredded paper stock. For example, animals that are brought into a veterinarian's office or a boarding facility, such as a kennel, may be either indoor or outdoor animals. It is common for animals that live outdoors at least a portion of the time to have a problem with fleas. However, the animals at a veterinarian's office or a kennel are not separated based on normal living conditions. Thus, any one of a number of animals that are on an overnight or extended stay with a veterinarian or other boarding facility may be suffering from fleas. Since the animals are maintained in close quarters with each other, the fleas may be easily spread from one animal to another. The shredded paper stock may be treated with flea deterrent to prevent the spread of fleas between the animals.

Certain scent treatments may require mixing with a suitable solvent prior to its application to the shredded paper stock. The solvent serves as a diluent or carrier to minimize the amount of scent necessary or to make the scent more potent. Suitable solvents, diluents or carriers may include, but are not limited to, ethanol, isopropanol, diethylene glycol, monoethyl ether, dipropylene glycol, diethyl phthalate and triethyl citrate. The amount of such solvents, diluents or carriers incorporated in the scent treatment depends on the scent treatment or the application for which it is being used.

At 135, the shredded paper stock is placed into a packaging material This material is preferably a plastic bag so that the bag may be vacuum sealed, as further described herein. The plastic packaging material may be made from any material, such as polyethylene, polypropylene, or polyvinyl chloride film sheet, so long as the bag does not allow air to readily pass through the packaging material. In some applications it may be desirable to compress the shredded paper stock before the packaging material is vacuum sealed to provide the maximum amount of product inside the package. The shredded paper stock may also be placed into any other appropriate packaging, including but not limited to, a cardboard box, a brown Kraft paper wrapping or a netted material. However, these materials are generally porous and cannot be vacuum sealed.

At 140, the packaging material is vacuum sealed, using conventional vacuum sealing techniques, to further compress the shredded paper stock. The top of the packaging material is drawn to prevent the leakage of air into the bag during the vacuum seal process, and the intake of a vacuum pump is inserted into the opening of the packaging material. The packaging material generally collapses as the air is drawn from the packaging material and the shredded paper stock is compressed to a smaller fraction of its original volume. When substantially all of the air has been drawn from the inside of the packaging material, the opening of the packaging material may be heat sealed. Alternatively, the packaging material can be taped, tied with a string or wire or otherwise closed to prevent the release of shredded paper stock from the packaging material during transport and storage. The vacuum sealed packages are flat and compact such that the packages can be stacked one on top of another for during transport or storage at 150.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An animal shred comprising:
an absorbent paper stock,
wherein the paper stock is folded into signature, shredded, dusted and packaged in a vacuum sealed package.

2. The animal shred of claim 1, wherein the paper stock is at least forty-pound paper.

3. The animal shred of claim 1, further comprising a design that is printed on the paper stock.

4. The animal shred of claim 3, wherein the design is printed on both sides of the paper stock.

5. The animal shred of claim 3, wherein the design is custom designed.

6. The animal shred of claim 3, wherein the design is printed on the paper stock using a web offset press.

7. The animal shred of claim 3, further comprising a soy-based ink that is used to print the design.

8. The animal shred of claim 1, further comprising a scent treatment that is applied to the printed paper stock.

9. The animal shred of claim 8, wherein the scent treatment is at least one of a cedar odorant and a flea deterrent.

10. The animal shred of claim 8, wherein the scent treatment is mixed with a solvent prior to application to the paper stock.

11. The animal shred of claim 10, wherein the solvent is dipropylene glycol.

12. The animal shred of claim 1, wherein the shred is dusted using one of a shaker and a vacuum removal system.

13. The animal shred of claim 1, wherein the shred is used as a filler for a cushion.

14. The animal shred of claim 13, wherein the cushion is disposable.

15. The animal shred of claim 1, wherein the shred is placed in an animal enclosure.

16. A process of manufacturing an animal shred comprising the steps of:
selecting a paper stock;
folding the paper stock into signature;
shredding the paper stock;
dusting the shredded paper stock using a dust collection system and
vacuum packaging the paper stock.

17. The animal shred of claim 16, wherein the paper stock is at least forty-pound paper.

18. The animal shred of claim 16, further comprising the step of creating a print design.

19. The animal shred of claim 18, further comprising the step of transferring the print design to the paper stock.

20. The animal shred of claim 19, wherein the print design is transferred to the paper stock using a web offset press.

21. The animal shred of claim 19, wherein the print design is transferred using a soy-based ink.

22. The animal shred of claim 16, further comprising the step of applying a scent treatment to the printed paper stock.

23. The animal shred of claim 22, wherein the scent treatment is at least one of a cedar odorant and a flea deterrent.

24. The animal shred of claim 22, wherein the scent treatment is mixed with a solvent prior to application to the paper stock.

25. The animal shred of claim 24, wherein the solvent is dipropylene glycol.

26. The animal shred of claim 16, wherein the dust collection system is one of a shaker and a vacuum removal system.

27. The animal shred of claim 16, wherein the shred is used as a filler for a cushion.

28. The animal shred of claim 27, wherein the cushion is disposable.

29. The animal shred of claim 16, wherein the bedding material is placed in an animal enclosure.
